(19) United States
(12) Patent Application Publication
(10) Pub. No.: US 2025/0198802 A1
(43) Pub. Date: Jun. 19, 2025

(54) MEASUREMENT SYSTEM

(71) Applicant: Cirrus Logic International Semiconductor Ltd., Edinburgh (GB)

(72) Inventors: David SMITH, Edinburgh (GB); James WELLS, Edinburgh (GB); Jayanth KALAGATLA, Edinburgh (GB); Payel MUKHERJEE, Edinburgh (GB)

(73) Assignee: Cirrus Logic International Semiconductor Ltd., Edinburgh (GB)

(21) Appl. No.: 18/544,675

(22) Filed: Dec. 19, 2023

(51) Int. Cl. G01D 3/032; H02M 3/155

(52) U.S. Cl. CPC G01D 3/032; H02M 3/155

(57) ABSTRACT

A measurement system comprising: power converter circuitry; and measurement circuitry, wherein the measurement circuitry is operative to control a timing of a refresh of the power converter circuitry so as to avoid conflict with a measurement operation.

### FIELD OF THE INVENTION

The present disclosure relates to a measurement system.

### BACKGROUND

Measurement systems such as those used in battery powered wearable or implantable monitoring devices such as blood glucose monitors, blood pressure monitors, ECG monitors, smart garments and the like typically include measurement circuitry for performing measurements and a DC-DC converter for providing a regulated power supply voltage to circuitry external to the measurement circuitry and DC-DC converter, e.g. a wireless communications subsystem such as a Bluetooth Low Energy (BLE) transmitter or transceiver that is operative to transmit measurement signals to an external device such as smartphone, tablet computer or other device that is wirelessly connected to the measurement system.

The measurement circuitry typically includes one or more sensors that (each) provide a sensor output signal such as an output current or voltage that is indicative of a measured or monitored parameter. The sensor output signal typically has a very low magnitude, for example of the order of nanoamps or nanovolts.

The external circuitry typically requires a relatively low supply voltage, e.g. 1.8 v. It is important for the DC-DC converter to operate with high efficiency to avoid unnecessary power consumption, as the measurement system is typically powered by a small capacity battery. DC-DC converters that operate with high efficiency at light loads typically have an uncontrolled range of switching frequencies.

Because the magnitude of switch currents in a DC-DC converter are significantly higher than the magnitude of the sensor output signals in the measurement circuitry, transients in the DC-DC converter can corrupt the sensor output signals. It is possible to suppress such transients with suitably configured filter circuitry. However, suppressing a range of frequencies (as may be present in DC-DC converters that operate with high efficiency at light loads) is more complex than suppressing a single frequency.

One approach to addressing the problem of corruption of sensor output signals by transients in DC-DC converter is to physically separate the DC-DC converter from the measurement circuitry, for example by implementing the DC-DC converter in a first integrated circuit (IC) and implementing the measurement circuitry in a second IC, separate from the first IC. This approach isolates the DC-DC converter from the measurement circuitry but increases the cost and physical space required for the measurement system, which are both important factors in the design of wearable or implantable monitoring devices.

An alternative approach is to use a constant frequency DC-DC converter. This approach makes it easier to suppress or filter transients in the DC-DC converter to reduce the risk of distortion of sensor output signals in the measurement circuitry. However, constant frequency DC-DC converters tend to have very poor power efficiency at light loads, and thus this approach leads to very poor power efficiency of the measurement system.

### SUMMARY

According to a first aspect, the invention provides a measurement system comprising: power converter circuitry; and measurement circuitry, wherein the measurement circuitry is operative to control a timing of a refresh of the power converter circuitry so as to avoid conflict with a measurement operation.

The power converter circuitry may comprise a power converter controller configured to: compare an output voltage of the power converter circuitry to a first predefined threshold; and responsive to a determination that the output voltage is below the first predefined threshold, output a refresh request signal to the measurement circuitry.

The measurement circuitry may comprise a measurement circuitry controller configured to: receive the refresh request signal from the power converter controller; determine if a measurement operation is in progress; and responsive to a determination that no measurement operation is in progress, output a refresh granted signal to the power converter controller.

The power converter controller may be configured to, responsive to the refresh granted signal, control a switch of the power converter circuitry to cause the output voltage of the power converter circuitry to increase to a level equal to or greater than the first predefined threshold.

The power converter controller may be further configured to: compare the output voltage of the power converter circuitry to a further predefined threshold; and responsive to a determination that the output voltage is below the further predefined threshold, indicate to the measurement circuitry that an error has occurred.

The measurement circuitry controller may be configured to, responsive to the indication from the power converter controller that an error has occurred, output a refresh granted signal to the power converter controller.

The power converter controller may be further configured to control the switch of the power converter circuitry to cause the output voltage of the power converter circuitry to increase to a level equal to or greater than the first predefined threshold without outputting a refresh request signal.

The measurement circuitry may comprise a measurement circuitry controller configured to output a force refresh signal to the power converter circuitry.

The measurement circuitry controller may be configured to output the force refresh signal prior to causing the measurement circuitry to perform a measurement operation.

The power converter circuitry may comprise a power converter controller configured to: receive the force refresh signal from the measurement circuitry controller; and in response to the control a switch of the power converter circuitry to cause the output voltage of the power converter circuitry to increase to a level equal to or greater than a second predefined threshold.

The measurement circuitry controller may be configured to invalidate the output of any measurement operations that are performed while the power converter controller is controlling the switch of the power to cause the output voltage of the power converter circuitry to increase.

The power converter controller may be further configured to output a refresh complete signal to the measurement circuitry controller.

The measurement circuitry controller may be further configured to cause the measurement circuitry to perform the measurement operation in response to receiving the refresh complete signal.

The measurement circuitry controller may be further configured to wait for a predetermined period of time after outputting the force refresh signal before causing the measurement circuitry to perform the measurement operation.

The power converter circuitry may comprise DC-DC converter circuitry comprising: an inductor; a first switch for controlling current through the inductor; and a monostable circuit configured to control an off-time of the first switch.

The DC-DC converter circuitry may further comprise: a second switch; and a first capacitor, wherein: the inductor and the first switch are coupled in series between a positive power supply voltage rail of the DC-DC converter and a reference voltage supply rail of the DC-DC converter; the second switch is coupled between a terminal of the inductor and an output node of the DC-DC converter; and the first capacitor is coupled between the output node and the reference voltage supply rail.

The monostable circuit may comprise: a constant current source configured to supply a charging current to a second capacitor; and an inverter having an input coupled to a first terminal of the second capacitor and an output coupled to a control terminal of the first switch, wherein the inverter is coupled to receive an inverter supply voltage, and wherein the inverter is operative to switch a state of a signal at its output when a magnitude of a voltage across the second capacitor reaches half of a magnitude of the inverter supply voltage.

The power converter circuitry may comprise switching boost converter circuitry.

The power converter circuitry and the measurement circuitry may be integrated in a single integrated circuit (IC).

The power converter circuitry may be configured to receive a power supply from a battery.

The measurement circuitry may be configured to receive a power supply from the battery.

The power converter circuitry may be configured to output a supply voltage to circuitry external to the IC.

The power converter circuitry may be configured to output a supply voltage to the measurement circuitry.

According to a second aspect, the invention provides a host device comprising the measurement system of the first aspect.

The host device may comprise a wearable monitoring device, an implantable monitoring device, a blood glucose monitor, a blood pressure monitor, an ECG monitor, a smart garment, a laptop, notebook, netbook or tablet computer, a gaming device, a games console, a controller for a games console, a virtual reality (VR) or augmented reality (AR) device, a mobile telephone, a portable audio player, a portable device, an accessory device for use with a wearable monitoring device, an implantable monitoring device, a blood glucose monitor, a blood pressure monitor, an ECG monitor, a smart garment, a laptop, notebook, netbook or tablet computer, a gaming device, a games console a VR or AR device, a mobile telephone, a portable audio player or other portable device.

According to a third aspect, the invention provides power converter circuitry configured to receive an input voltage and output an output voltage, the power converter circuitry comprising: an inductor; a first switch for controlling a current through the inductor; a capacitor; and a monostable circuit configured to control an off-time of the first switch.

According to a fourth aspect, the invention provides a monostable circuit comprising: a first power supply rail configured to receive a supply voltage; a reference voltage supply rail; a constant current source; a capacitor; and an inverter, wherein: the constant current source is configured to supply a charging current to the capacitor; the inverter is coupled to receive a power supply; and an input of the inverter is coupled to the capacitor, such that a state of an output of the inverter switches when a magnitude of a voltage across the capacitor reaches half a magnitude of the supply voltage.

According to a fifth aspect, the invention provides power converter circuitry for the measurement system of the first aspect, the power converter circuitry comprising a power converter controller configured to: compare an output voltage of the power converter circuitry to a first predefined threshold; responsive to a determination that the output voltage is below the first predefined threshold, output a refresh request signal; and responsive to receiving a refresh granted signal, control a switch of the power converter circuitry to cause an output voltage of the power converter circuitry to increase to a level equal to or greater than a first predefined threshold.

According to a sixth aspect, the invention provides measurement circuitry for the measurement system of the first aspect, the measurement circuitry comprising a measurement circuitry controller configured to output a force refresh signal prior to causing the measurement circuitry to perform a measurement operation.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a measurement system according to the present disclosure;

FIG. 2 provides flow charts illustrating operation of the DC-DC converter controller and measurement circuitry controller of the measurement system of FIG. 1 in a request refresh procedure;

FIG. 3 provides flow charts illustrating operation of the DC-DC converter controller and measurement circuitry controller of the measurement system of FIG. 1 in a forced refresh procedure; and

FIG. 4 is a schematic representation of DC-DC converter circuitry which may be used as the power converter circuitry in the measurement system of FIG. 1.

### DETAILED DESCRIPTION

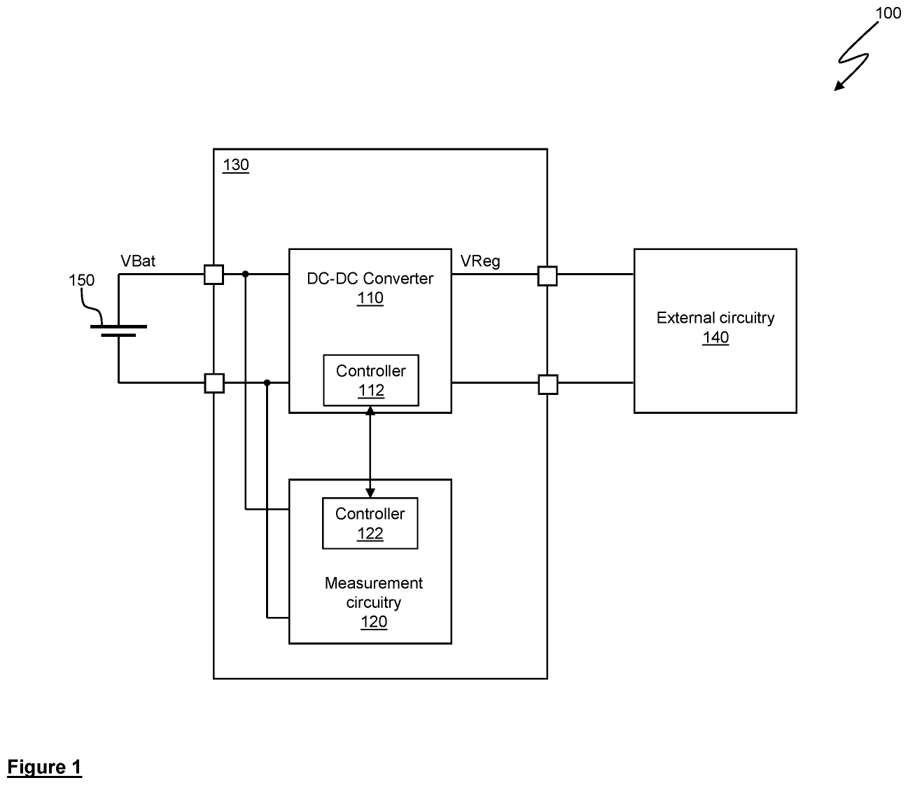

Referring first to FIG. 1, a measurement system is shown generally at 100. The measurement system comprises a DC-DC converter 110 and measurement circuitry 120. In the example shown in FIG. 1 the DC-DC converter 110 and the measurement circuitry 120 are integrated in a single integrated circuit (IC) device 130. However, the present disclosure is not limited to such examples, but also encompasses examples in which the DC-DC converter 110 is implemented in a first IC device and the measurement circuitry is implemented in a second IC device which is separate from the first IC device.

The measurement system 100 may further include off-chip or external circuitry 140 (i.e. circuitry that is external to the IC 130), which may be, for example, communications circuitry implementing a Bluetooth Low Energy (BLE) transmitter or transceiver or the like, processing circuitry such as a microprocessor, microcontroller or the like, or some other external circuitry.

The measurement system 100 receives a power supply voltage VBat from a battery 150, to power the DC-DC converter 110 and the measurement circuitry 120. The DC-DC converter 110, which may comprise switching DC-DC converter circuitry, for example, is configured to receive the power supply voltage VBat from the battery 130 and output a regulated supply voltage VReg to the external circuitry 140. In some examples the DC-DC converter 110 may, additionally or alternatively, output a regulated supply voltage to the measurement circuitry 120.

The DC-DC converter 110 in this example is configured as a boost converter, such that a magnitude of the regulated supply voltage VReg output to the external circuitry 140 is greater than a magnitude of the power supply voltage VBat received from the battery 130. For example, the battery 130 may have a nominal output voltage of 1.5 v, and the DC-DC converter 110 may output a regulated supply voltage of 1.8 v. However, in other examples the DC-DC converter 110 may be configured as buck converter circuitry, such that the magnitude of the regulated supply voltage VReg to the external circuitry 140 is less than that of the battery supply voltage VBat.

The DC-DC converter 110 includes a DC-DC converter controller 112 configured to control operation of the DC-DC converter 110. The DC-DC converter controller 112 may comprise, for example, a microcontroller, a state machine, a microprocessor or discrete circuitry configured to perform the steps described below.

Similarly, the measurement circuitry 120 includes a measurement circuitry controller 122. The measurement circuitry controller 122 may comprise, for example, a microcontroller, a state machine, a microprocessor or discrete circuitry configured to perform the steps described below. The measurement circuitry 120 is configured to perform a measurement operation such as a blood glucose measurement, a blood pressure measurement, an ECG measurement or any other measurement. The measurement circuitry 120 may comprise digital circuitry, analog circuitry or a combination of digital and analog circuitry configured to perform the measurement operation. The specific configuration of the measurement circuitry 120 is not relevant to the present disclosure. Those of ordinary skill in the art will be familiar with suitable circuitry for performing particular measurements.

As will be appreciated by those of ordinary skill in the art, the regulated output voltage VReg output by the DC-DC converter 110 will drop over time due to the quiescent power consumption of the external circuitry 140 and leakage. Additionally, when the external circuitry 140 is active (e.g. transmitting or receiving a signal), its power consumption increases and the regulated output voltage VReg droops, due to the increased current that is drawn from the DC-DC converter 110.

The DC-DC converter 110 must therefore “refresh” the regulated output voltage VReg occasionally or periodically, in order to maintain the regulated output voltage VReg within a predefined voltage range. This is achieved by controlling one or more switches of the DC-DC converter 110 to couple the battery 130 to an energy storage component of the DC-DC converter 110 to permit current to flow from the battery 130 to one or more energy storage components (e.g. an inductor or a capacitor) of the DC-DC converter 110.

As noted above, however, operating switches of the DC-DC converter 110 in this way while the measurement circuitry 120 is performing a measurement operation can corrupt measurement signals generated by the measurement circuitry 120.

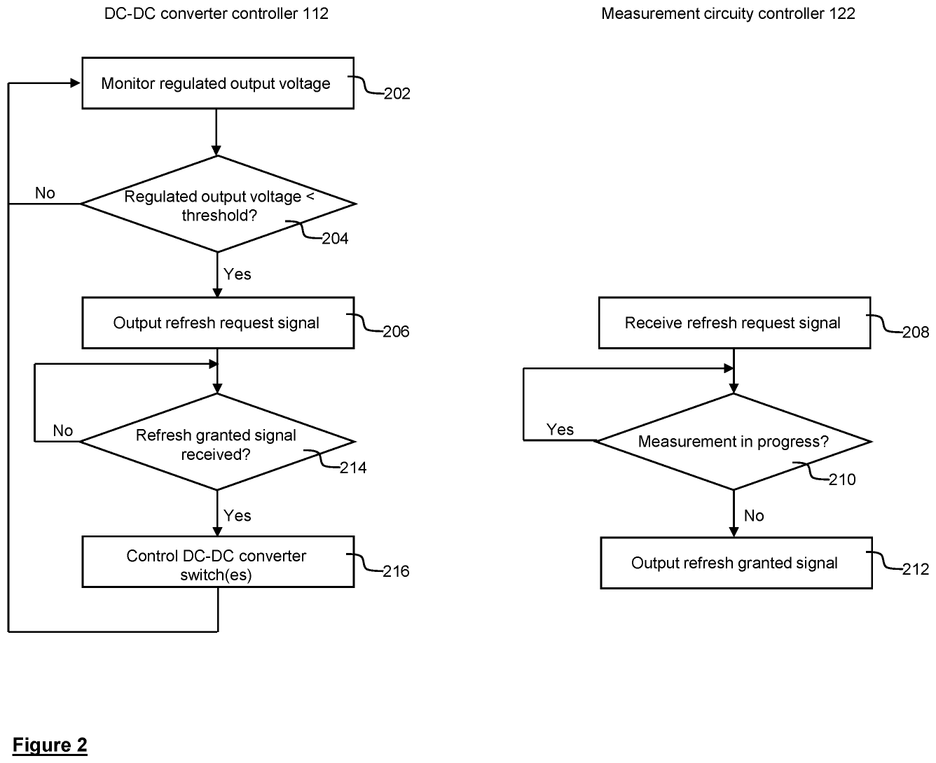

To reduce the risk of such corruption of measurement signals, the measurement system 100 is configured to perform a refresh request procedure, as will now be described with reference to FIG. 2.

The DC-DC converter controller 112 is operative to monitor the regulated supply voltage VOut output by the DC-DC converter 110 (at step 202 of FIG. 2) and to compare the regulated supply voltage VOut to a first predefined threshold to determine whether the energy storage component(s) of the DC-DC converter 110 need to be recharged (step 204). When the regulated supply voltage VOut falls below the first predefined threshold, this is indicative that recharging or refreshing of the energy storage component(s) is required. However, the DC-DC converter controller 112 of the measurement system 100 does not immediately control the relevant switch(es) of the DC-DC converter 110 to cause current to be drawn from the battery 130 as described above. Instead, in response to determining that the regulated supply voltage VOut is below the first predefined threshold, the DC-DC converter controller 112 outputs a “refresh request” signal to the measurement circuitry controller 122 (step 206) and awaits a response from the measurement circuitry controller 122.

On receiving a “refresh request” signal from the DC-DC converter controller 112 (step 208), the measurement circuitry controller 122 determines whether a measurement operation is in progress (step 210). If no measurement operation is in progress, the DC-DC converter controller 112 outputs a “refresh granted” signal to the DC-DC converter controller 112 (step 212). However, if the measurement circuitry controller 122 determines that a measurement is in progress, the refresh granted signal is not output to the DC-DC converter controller 112, and the measurement circuitry controller 122 returns to step 210 to determine whether a measurement is still in progress. Thus, a refresh granted signal is only output by the measurement circuitry controller 122 to the DC-DC converter controller 112 when a measurement performed by the measurement circuitry 120 has been completed.

On receiving the refresh granted signal from the measurement circuitry controller 122, the DC-DC converter controller 112 controls the relevant switch(es) of the DC-DC converter 110 to refresh the regulated output voltage of the DC-DC converter 110 (step 216).

While the DC-DC converter controller 112 is controlling the relevant switch(es) of the DC-DC converter 110 to refresh the regulated output voltage VReg, the DC-DC converter controller 112 continues to monitor the regulated output voltage VReg (step 202) and compare it to the first predefined threshold (step 204). The DC-DC converter controller 112 continues to output the refresh request signal (step 206) until the regulated output voltage VReg has increased to a level equal to or greater than the first predefined threshold, at which point the DC-DC converter controller 112 stops outputting the refresh request signal.

This refresh request procedure prevents operation of the relevant switch(es) of the DC-DC converter 110 while a noise-sensitive measurement operation is being performed by the measurement circuitry 120, thus reducing the risk of transients and/or switching noise in the DC-DC converter 110 arising from operation of the switch(es) corrupting measurement signals generated by the measurement circuitry 120 during the measurement operation.

In some examples, the DC-DC converter controller 112 may be operative to compare the regulated supply voltage VOut to a further predefined threshold, which is lower than the first predefined threshold. If the regulated output voltage drops below this further predefined threshold (e.g. because a refresh granted signal has not been received from the measurement circuitry controller 122, or has not been received in time to prevent the regulated output supply voltage VOut from falling below the further predefined threshold), the DC-DC converter controller 112 may output an error signal or raise an error flag to signal to the measurement circuitry controller 122 that an error has occurred.

In some examples, the boost controller converter circuitry 112 may be configured to control the relevant switch(es) of the DC-DC converter 110 to refresh the regulated output voltage of the DC-DC converter 110 without outputting a refresh request signal to the measurement circuitry controller 122 and awaiting a response from the measurement circuitry controller 122 in certain circumstances.

For example, if the regulated supply voltage VOut falls below the first predefined threshold, the further predefined threshold or another predefined threshold, different from the first and further thresholds, the boost controller converter circuitry 112 may immediately control the relevant switch(es) of the DC-DC converter 110 to refresh the regulated output voltage of the DC-DC converter 110 without transmitting a refresh request signal.

In such examples, the measurement circuitry controller 122 may be configured to invalidate the outputs of any measurement operations taken while the regulated supply voltage VOut of the DC-DC converter 110 is being refreshed. In such examples the DC-DC converter controller 112 may output a signal indicating that the regulated supply voltage VOut is being refreshed to the measurement circuitry controller 122, or alternatively the measurement circuitry controller 122 may detect that the regulated supply voltage VOut is being refreshed. In response to such a signal or detection, the measurement circuitry controller 122 may output a signal indicating that measurement signals are invalid, or may blank measurement signals (e.g. by setting them to a predefined value), or may prevent or disable output of measurement signals by the measurement circuitry 120, until the supply voltage VOut has been refreshed. Once the supply voltage VOut has been refreshed (which may be indicated by the DC-DC converter circuitry outputting a suitable signal to the measurement circuitry controller 122, e.g. a refresh complete signal of the kind described above, or may be detected by the measurement circuitry controller 122), the measurement circuitry controller 122 may stop outputting the signal indicating that measurement signals are invalid, or may stop blanking measurement signals, or may re-enable output of measurement signals as appropriate.

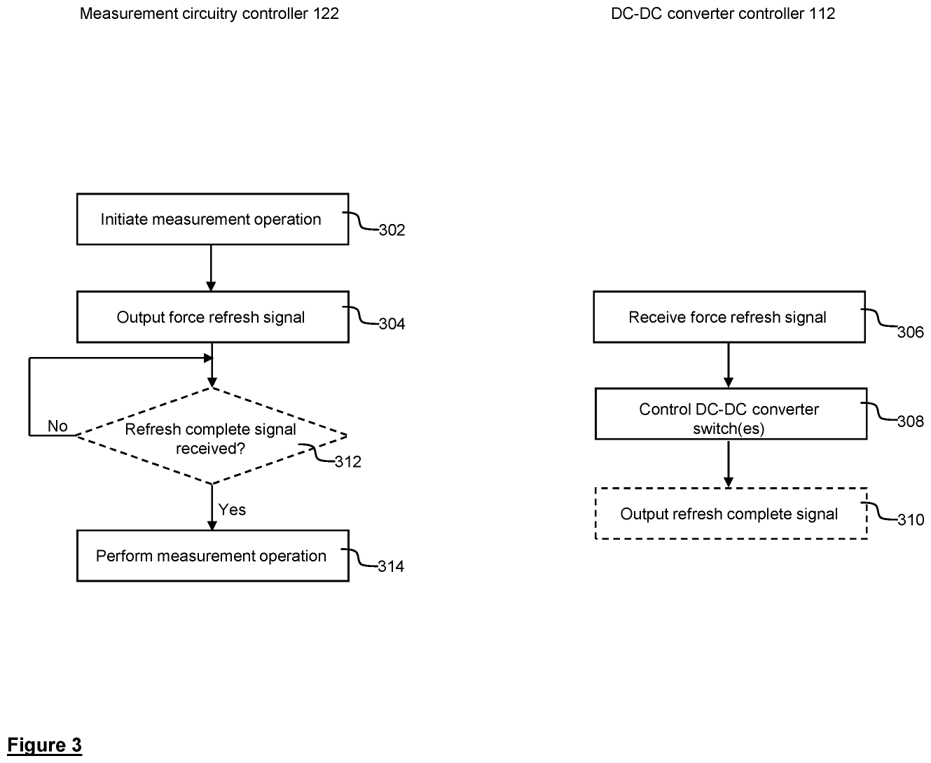

Additionally or alternatively, the measurement system 100 may be configured to perform a forced refresh procedure, to (further) reduce the risk of corruption of measurement signals generated by the measurement circuitry 120, as will now be described with reference to FIG. 3.

In a first step 302 of the forced refresh procedure, a measurement operation is initiated. The measurement operation may be, for example, a periodic measurement initiated in response to a clock signal received or generated by the measurement circuitry controller 122, or may be a one-off measurement initiated in response to a measurement initiation signal received or generated by the measurement circuitry controller 122.

In response to initiation of the measurement operation, the measurement circuitry controller 122 outputs, at step 304, a force refresh signal to the DC-DC converter controller 112.

On receiving the force refresh signal, the DC-DC converter controller 112 controls, at step 308 the relevant switch(es) of the DC-DC converter 110 to recharge the energy storage component(s) of the DC-DC converter 110. In some examples, the DC-DC converter controller 112 may output a refresh complete signal to the measurement circuitry controller 122 once the regulated output voltage VReg of the DC-DC converter 110 has reached a second predefined threshold (which may be the same as the first predefined threshold used in the refresh request procedure described above with reference to FIG. 2, or may be a different threshold specific to the forced refresh procedure).

In such examples, the measurement circuitry controller 122 waits until a refresh complete signal is received from the DC-DC converter controller 112. On receiving the refresh complete signal from the DC-DC converter controller 112, the measurement circuitry controller 122 causes the measurement circuitry 120 to perform the measurement operation (step 314).

In examples in which the DC-DC converter controller 112 is not configured to output a refresh complete signal, instead of waiting for a refresh complete signal the measurement circuitry controller 122 may wait for a predetermined period of time after outputting the force refresh signal before moving to step 314 to cause the measurement circuitry 120 to perform the measurement operation.

This forced refresh request procedure ensures that the regulated output voltage VReg of the DC-DC converter 110 is increased to (or close to) an upper threshold thereof before the measurement circuitry 120 performs a measurement, thus minimising droop in the regulated output voltage VReg while the measurement is being performed. This ensures that an accurate measurement signal can be generated by the measurement circuitry 120 and reduces the likelihood that the DC-DC converter circuitry 110 will need to be refreshed during the period in which the measurement circuitry 120 is performing the measurement.

It should be noted that a force refresh signal can be output by the measurement circuitry controller 122 at any time, and not only when a measurement operation has been initiated. For example, it may be desirable to output a force reset signal prior to a calibration of the measurement circuitry 120, or in other circumstances.

In particular, if the DC-DC converter controller 112 detects that the regulated supply voltage VOut has fallen below the further threshold described above with reference to the refresh request procedure during a measurement operation, the measurement circuitry controller 122 may immediately output a force refresh signal, or alternatively a refresh grated signal, to the DC-DC converter controller 112 (e.g. in response to an error signal or error flag output or raised by the DC-DC converter controller 112) to cause the DC-DC-converter controller 112 to refresh the regulated supply voltage VOut, and may also output an error signal or raise an error flag.

The measurement circuitry controller 122 may be configured to invalidate the results of any measurement operations that are performed while the regulated supply voltage VOut is being refreshed, as described above.

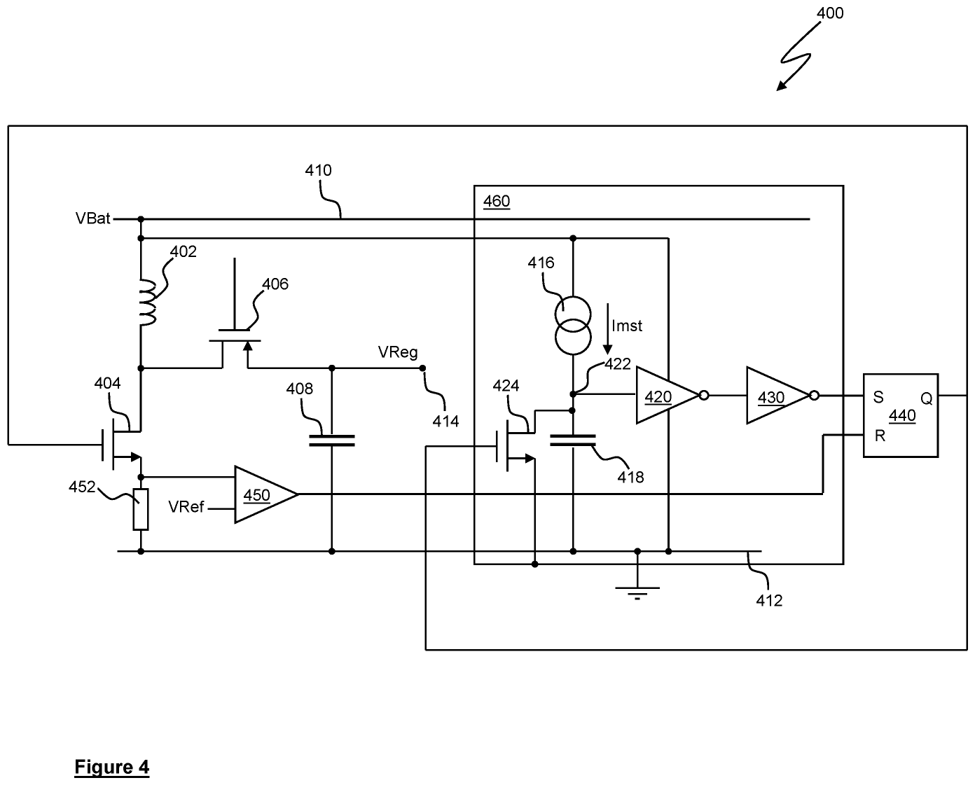

FIG. 4 is a schematic representation of example DC-DC converter circuitry which may be used to implement the DC-DC converter 110 of the measurement system 100 of FIG. 1.

The DC-DC converter circuitry, shown generally at 400 in FIG. 4, is configured as a boost converter that operates in a continuous conduction mode, and includes an inductor 402, a first switch 404, a second switch 406 and a first capacitor 408. In some examples the second switch may be replaced by a diode or similar device. For clarity and simplicity the following description will refer to a second switch, but it is to be understood that the term “second switch” is intended to encompass a diode or similar device.

The inductor 402 is coupled in series with the first switch 404 between a positive power supply rail 410 that receives the power supply voltage VBat and a ground (or other reference voltage) supply rail 412. In the example shown in FIG. 4, the first switch 404 is an NMOS device. A first terminal of the inductor 402 is coupled to the positive power supply rail 410 and a second terminal of the inductor 402 is coupled to a drain terminal of the first switch 404. A source terminal of the first switch is coupled to the ground supply rail 412. Thus, when the first switch 404 is switched on (in response to a suitable control signal supplied to its gate terminal), the inductor 402 is coupled between the positive power supply rail 410 and the ground rail 412 such that the supply voltage VBat develops across the inductor 402 and current through the inductor 402 increases.

The second switch 406 is coupled in series between the second terminal of the inductor 402 and an output node 414 of the DC-DC converter circuitry 400, at which the regulated output voltage VReg develops, and to which a load such as the external circuitry 140 of the measurement system 100 of FIG. 1 can be coupled. In examples in which the second switch 406 is replaced by a diode, an anode of the diode is coupled to the second terminal of the inductor 402 and a cathode of the diode is coupled to the output node 414.

The first capacitor 408 is coupled between the output node 414 and the ground rail 412.

In the example shown in FIG. 4, the second switch 406 is a PMOS device having a drain terminal coupled to the second terminal of the inductor 402 and a source terminal coupled to the output node 414. Thus, when the second switch 406 is switched on (in response to a suitable control signal supplied to its gate terminal) and the first switch 404 is switched off, current can flow from the inductor 402 to the first capacitor 408 and to a load that is coupled to the output node 414. It will be appreciated by those of ordinary skill in the art that the second switch 406 could be an NMOS device instead of a PMOS device, with suitable adaptations to the DC-DC converter circuitry 400, which will be readily apparent to those of ordinary skill in the art.

The DC-DC converter circuitry 400 further includes a constant current source 416, a second capacitor 418, a first inverter 420, a third switch 424, a second inverter 430, logic circuitry 440, a comparator 450 and a current sense resistor 452.

The constant current source 416 is configured to supply a constant current to the second capacitor 418. In the illustrated example the constant current source 416 and the second capacitor 418 are coupled in series between the first terminal of the inductor 402 and the ground rail 412, but it will be appreciated by those of ordinary skill in the art that other arrangements in which the constant current source 416 is coupled to the second capacitor 418 so as to supply a constant current to the second capacitor 418.

A first power supply terminal of the inverter 420 is coupled to the first terminal of the inductor 402 and a second power supply terminal of the first inverter 420 is coupled to the ground supply rail 412, such that the first inverter 420 receives a first inverter supply voltage from the first terminal of the inductor 402 and the ground supply rail 412.

An input of the first inverter 420 is coupled to a node 422 between the current source and the second capacitor 418. An output of the first inverter 420 is coupled to an input of the second inverter 430.

The third switch 424, which in the illustrated example is an NMOS device, is coupled between the node 422 and the ground supply rail 412.

In the illustrated example the logic circuitry 440 implements an S-R flip flop. An output of the second inverter 430 is coupled to a S (set) input of the logic circuitry 440. An output of the logic circuitry 440 is coupled to control terminal (e.g. a gate terminal) of the first switch 404 and to a control terminal (e.g. a gate terminal of the third switch 424.

The current sense resistor 452 is coupled in series between the first switch 406 and the ground supply rail 412. In use of the DC-DC converter circuitry 400, a voltage indicative of a current through the inductor 402 develops across the current sense resistor 452.

A first input of the comparator 450 is coupled to a first terminal of the current sense resistor 452 such that the first input of the comparator receives the voltage indicative of the current through the inductor 404. A second input of the comparator 450 is coupled to a reference voltage supply VRef, so as to receive a reference voltage, which may be of the order of 50 mV, for example. An output of the comparator 450 is coupled to an R (reset) input of the logic circuitry 440.

In operation of the DC-DC converter circuitry 400, during a first phase (which may be referred to as a charging phase), the Q output of the logic circuitry 440 is high, such that the first switch 404 and the third switch 424 are switched on. Current thus increases through the inductor 402, and the voltage across the current sense resistor 452 also increases. During this first phase, the input of the first inverter 420 is coupled to the ground supply rail 412 such that the output of the first inverter 420 is high and the output of the second inverter 430 is low, such that the S input of the logic circuitry 440 is also low. The Q output remains high, however, until the R input of the logic circuitry 440 goes high.

When the voltage across the current sense resistor 452 reaches or exceeds the reference voltage VRef, the output of the comparator 450 goes high. The R input of the logic circuitry 440 also goes high, causing the Q output of the logic circuitry 440 to go low, thus switching off the first switch 404 and the third switch 424.

When the first switch 404 switches off, the second switch 406 switches on, in response to a suitable control signal supplied to its control (e.g. base) terminal, to start a second phase (which may be referred to as a discharging phase) of operation of the DC-DC converter circuitry 400. In this second phase, current flows from the inductor 402 through the second switch 406 to the first capacitor 408 and the load that is coupled to the output node 414.

During this second phase, the constant current source 416 supplies a charging current to the second capacitor 418, causing the voltage across the second capacitor 418 to increase. When the magnitude of the voltage across the second capacitor 418 reaches half the magnitude of the first inverter supply voltage (i.e. VBat/2), a state of a signal at the output of the first inverter 420 switches (in the illustrated example from high to low). The output of the second inverter 430 thus also switches (in the illustrated example from low to high), which causes the Q output of the logic circuitry 440 to go high, thus switching on the first and third switches 404, 424, to start a new first phase of operation of the DC-DC converter circuitry 400.

The combination of the first and second inverters 420, 430, constant current source 416, second capacitor 418 and third switch 424 thus acts as a monostable circuit 460 that controls the duration for which the first switch 404 is switched off (i.e. the off-time of the first switch 404) on a cycle-by-cycle basis.

As will be appreciated by those skilled in the art, the duty cycle D of a boost converter operating a continuous conduction mode is defined by the relationship:

$$D = ( 1 - \frac{V in}{V out} ) \qquad ( 1 )$$

where Vin is the input voltage to the boost converter and Vout is the output voltage of the boost converter.

The period Tsw of a complete switching cycle of such a boost converter is defined as:

$$Tsw = to n + toff \qquad ( 2 )$$

where ton is the period for which the first switch 404 is switched on, and toff is the period for which the first switch 404 is switched off.

In the DC-DC converter circuitry 400 of FIG. 4, the period for which the first switch 404 is switched off is defined by the time period of the monostable circuit 430.

The time period of the monostable circuit 430 is in turn defined by the time taken for the voltage across the second capacitor 418 to reach half the supply voltage. The current Imst through a capacitor is defined by the relationship:

$$Imst = C \frac{d V}{d t} \qquad ( 3 )$$

where C is the capacitance of the capacitor and V is the voltage across the capacitor.

From this it follows that:

$$t = C \frac{V}{I m s t} \qquad ( 4 )$$

In the DC-DC converter circuitry 400 of FIG. 4, the time period of the monostable circuit 430 is thus

$$tmst = Cmst \frac{V Bat / 2}{I m s t} \qquad ( 5 )$$

where Imst is the current output by the constant current source 416 and Cmst is the capacitance of the second capacitor 418.

The capacitance Cmst is and the current Imst are constant, such that equation (5) above can be rewritten as:

$$tmst = k . V Bat \qquad ( 6 )$$

where k is a constant equal to

$$\frac{C m s t}{2 . I m s t} .$$

Thus, in the DC-DC converter circuitry 400 of FIG. 4, the cycle period Tsw can be defined as:

$$Tsw = to n + k . V Bat \qquad ( 7 )$$

The duration of the period ton for which the first switch 404 is switched on is related to the duty cycle D of the DC-DC converter circuitry 400 as follows:

$$t on = \frac{D . toff}{1 - D} \qquad ( 8 )$$

In the DC-DC converter circuitry toff is equal to tmst, such that:

$$t on = \frac{D . tmst}{1 - D} \qquad ( 9 )$$

Thus,

$$Tsw = tmst . \frac{1}{1 - D} \qquad ( 10 )$$

Substituting relationship (1) into relationship (10):

$$Tsw = tmst \frac{V out}{V in} \qquad ( 11 )$$

For the DC-DC converter circuitry 400 of FIG. 4, Vout=VReg and Vin=VBat.

The switching frequency fsw of the DC-DC converter circuitry 400 is the reciprocal of the cycle period Tsw. Thus:

$$f s w = \frac{V Bat}{V Reg} . \frac{1}{t m s t} \qquad ( 12 )$$

Substituting relationship (6) into relationship (12):

$$f s w = \frac{V Bat}{V Reg} . \frac{1}{k V Bat} = \frac{1}{k V Reg} \qquad ( 13 )$$

From relationship (13) above, it is clear that the switching frequency fsw of the DC-DC converter circuitry 400 is independent of the supply voltage VBat. Instead, the switching frequency fsw is inversely proportional to the regulated output voltage VReg of the DC-DC converter circuitry 400.

As the DC-DC converter circuitry 400 is configured to maintain the regulated output voltage VReg within a relatively narrow voltage range, an effect of the monostable circuit 460 of the DC-DC converter circuitry 400 is to reduce the range of switching frequencies of the DC-DC converter circuitry 400, in comparison to conventional DC-DC converters. This in turn makes it easier to filter out or suppress, in the measurement circuitry 120, switching noise and/or transients generated by the DC-DC converter circuitry 400 that may otherwise corrupt or otherwise interfere with measurement signals generated by the measurement circuitry 120 when it is performing a measurement operation.

As will be appreciated by those of ordinary skill in the art, the monostable circuit 460 made up of the constant current source 416, the second capacitor 418, the first and second inverters 420, 430 and the third switch 424 in FIG. 4 is merely one example of a monostable circuit that could be used to control the off-time of the first switch 404, and other monostable circuit configurations or topology could equally be used to control the off-time of the first switch 404.

As will be appreciated by those of ordinary skill in the art, the DC-DC converter circuitry of FIG. 4 is suitable for use in a wide variety of systems, particularly in systems in which the performance or operation of a circuit or other load that receives a power supply from a DC-DC converter is susceptible to switching noise and/or transients that may be generated by the DC-DC converter. It will therefore be appreciated that the DC-DC converter circuitry 400 may find application in systems other than the measurement system 100 of FIG. 1.

The measurement system 100 of the present disclosure may employ any one of, or any combination of two or more of, the refresh request procedure described above with respect to FIG. 2, the forced refresh procedure described above with respect to FIG. 3, and the DC-DC converter circuitry 400 described above with respect to FIG. 4.

The measurement system and/or circuitry described above with reference to the accompanying drawings may be incorporated in a host device such as a wearable or implantable monitoring device such as a blood glucose monitor, a blood pressure monitor, an ECG monitor, or a smart garment laptop, or in a host device such as a notebook, laptop, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a wearable or implantable monitoring device, a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A measurement system comprising:
power converter circuitry; and
measurement circuitry, wherein the measurement circuitry is operative to control a timing of a refresh of the power converter circuitry so as to avoid conflict with a measurement operation.

2. The measurement system of claim 1, wherein the power converter circuitry comprises a power converter controller configured to:
compare an output voltage of the power converter circuitry to a first predefined threshold; and
responsive to a determination that the output voltage is below the first predefined threshold, output a refresh request signal to the measurement circuitry.

3. The measurement system of claim 2, wherein the measurement circuitry comprises a measurement circuitry controller configured to:
receive the refresh request signal from the power converter controller;
determine if a measurement operation is in progress; and
responsive to a determination that no measurement operation is in progress, output a refresh granted signal to the power converter controller.

4. The measurement system of claim 3, wherein the power converter controller is configured to, responsive to the refresh granted signal, control a switch of the power converter circuitry to cause the output voltage of the power converter circuitry to increase to a level equal to or greater than the first predefined threshold.

5. The measurement system of claim 2, wherein the power converter controller is further configured to:
compare the output voltage of the power converter circuitry to a further predefined threshold; and
responsive to a determination that the output voltage is below the further predefined threshold, indicate to the measurement circuitry that an error has occurred.

6. The measurement system of claim 5, wherein the measurement circuitry controller is configured to, responsive to the indication from the power converter controller that an error has occurred, output a refresh granted signal to the power converter controller.

7. The measurement circuitry of claim 4, wherein the power converter controller is further configured to control the switch of the power converter circuitry to cause the output voltage of the power converter circuitry to increase to a level equal to or greater than the first predefined threshold without outputting a refresh request signal.

8. The measurement system of claim 1, wherein the measurement circuitry comprises a measurement circuitry controller configured to output a force refresh signal to the power converter circuitry.

9. The measurement system of claim 8, wherein the measurement circuitry controller is configured to output the force refresh signal prior to causing the measurement circuitry to perform a measurement operation.

10. The measurement system of claim 8, wherein the power converter circuitry comprises a power converter controller configured to:
receive the force refresh signal from the measurement circuitry controller; and
in response to the control a switch of the power converter circuitry to cause the output voltage of the power converter circuitry to increase to a level equal to or greater than a second predefined threshold.

11. The measurement circuitry of claim 10, wherein the measurement circuitry controller is configured to invalidate the output of any measurement operations that are performed while the power converter controller is controlling the switch of the power to cause the output voltage of the power converter circuitry to increase.

12. The measurement system of claim 10, wherein the power converter controller is further configured to output a refresh complete signal to the measurement circuitry controller.

13. The measurement system of claim 11, wherein the measurement circuitry controller is further configured to cause the measurement circuitry to perform the measurement operation in response to receiving the refresh complete signal.

14. The measurement system of claim 8, wherein the measurement circuitry controller is further configured to wait for a predetermined period of time after outputting the force refresh signal before causing the measurement circuitry to perform the measurement operation.

15. The measurement system of claim 1, wherein the power converter circuitry comprises DC-DC converter circuitry comprising:
an inductor;
a first switch for controlling current through the inductor; and
a monostable circuit configured to control an off-time of the first switch.

16. The measurement system of claim 15, wherein the DC-DC converter circuitry further comprises:
a second switch; and
a first capacitor, wherein:
the inductor and the first switch are coupled in series between a positive power supply voltage rail of the DC-DC converter and a reference voltage supply rail of the DC-DC converter;
the second switch is coupled between a terminal of the inductor and an output node of the DC-DC converter; and
the first capacitor is coupled between the output node and the reference voltage supply rail.

17. The measurement system of claim 15, wherein the monostable circuit comprises:
a constant current source configured to supply a charging current to a second capacitor; and
an inverter having an input coupled to a first terminal of the second capacitor and an output coupled to a control terminal of the first switch,
wherein the inverter is coupled to receive an inverter supply voltage,
and wherein the inverter is operative to switch a state of a signal at its output when a magnitude of a voltage across the second capacitor reaches half of a magnitude of the inverter supply voltage.

18. The measurement system of claim 1, wherein the power converter circuitry comprises switching boost converter circuitry.

19. The measurement system of claim 1, wherein the power converter circuitry and the measurement circuitry are integrated in a single integrated circuit (IC).

20. The measurement system of claim 1, wherein the power converter circuitry is configured to receive a power supply from a battery.

21. The measurement system of claim 20, wherein the measurement circuitry is configured to receive a power supply from the battery.

22. The measurement system of claim 20, wherein the power converter circuitry is configured to output a supply voltage to circuitry external to the IC.

23. The measurement system of claim 20, wherein the power converter circuitry is configured to output a supply voltage to the measurement circuitry.

24. A host device comprising the measurement system of claim 1.

25. The host of claim 24, wherein the host device comprises a wearable monitoring device, an implantable monitoring device, a blood glucose monitor, a blood pressure monitor, an ECG monitor, a smart garment, a laptop, notebook, netbook or tablet computer, a gaming device, a games console, a controller for a games console, a virtual reality (VR) or augmented reality (AR) device, a mobile telephone, a portable audio player, a portable device, an accessory device for use with a wearable monitoring device, an implantable monitoring device, a blood glucose monitor, a blood pressure monitor, an ECG monitor, a smart garment, a laptop, notebook, netbook or tablet computer, a gaming device, a games console a VR or AR device, a mobile telephone, a portable audio player or other portable device.

26. Power converter circuitry configured to receive an input voltage and output an output voltage, the power converter circuitry comprising:
an inductor;
a first switch for controlling a current through the inductor;
a capacitor; and
a monostable circuit configured to control an off-time of the first switch.

27. A monostable circuit comprising:
a first power supply rail configured to receive a supply voltage;
a reference voltage supply rail;
a constant current source;
a capacitor; and
an inverter, wherein:
the constant current source is configured to supply a charging current to the capacitor;
the inverter is coupled to receive a power supply; and
an input of the inverter is coupled to the capacitor, such that a state of an output of the inverter switches when a magnitude of a voltage across the capacitor reaches half a magnitude of the supply voltage.

28. Power converter circuitry for the measurement system of claim 1, the power converter circuitry comprising a power converter controller configured to:
compare an output voltage of the power converter circuitry to a first predefined threshold;
responsive to a determination that the output voltage is below the first predefined threshold, output a refresh request signal; and
responsive to receiving a refresh granted signal, control a switch of the power converter circuitry to cause an output voltage of the power converter circuitry to increase to a level equal to or greater than a first predefined threshold.

29. Measurement circuitry for the measurement system of claim 1, the measurement circuitry comprising a measurement circuitry controller configured to output a force refresh signal prior to causing the measurement circuitry to perform a measurement operation.
